(19) United States
(12) Patent Application Publication
(10) Pub. No.: US 2026/0260122 A1
(43) Pub. Date: Sep. 3, 2026

(54) ADVERSARIAL TRAINING OF A MODEL FOR QUESTION ANSWERING

(71) Applicants: Beijing Youzhuju Network Technology Co., Ltd., Pinggu District, Beijing (CN); Lemon Inc., Grand Cayman (KY)

(72) Inventors: Rui Zheng, Beijing (CN); Xiaoying Zhang, Beijing (CN); Yuanshun Yao, Los Angeles, CA (US); Xiaojun Xu, Los Angeles, CA (US); Yang Liu, Los Angeles, CA (US)

(21) Appl. No.: 19/099,760

(22) PCT Filed: Jun. 5, 2024
(86) PCT No.: PCT/CN2024/097563

§ 371 Date: Jan. 29, 2025

(51) Int. Cl. G06N 3/092; G06N 3/045

(52) U.S. Cl. CPC G06N 3/092; G06N 3/045

(57) ABSTRACT

Embodiments of the present disclosure provide a solution for adversarial model training. A method includes: generating a prompt input using an adversarial machine learning model; providing the prompt input to a target machine learning model, to generate a response to the prompt input; determining a first reward score for the response with respect to the prompt input; and fine-tuning the target machine learning model according to a first optimization objective, the first optimization objective being configured to increase or maximize the first reward score for the target machine learning model.

### FIELD

The disclosed example embodiments relate generally to machine learning and, more particularly, to a method, apparatus, device and computer readable storage medium for adversarial training of a model for question answering.

### BACKGROUND

Machine learning models (such as Language Models (LMs)) are capable of performing a wide range of Natural Language Processing (NLP) tasks, including but not limited to question answering, text generation, summarization, translation, and sentiment analysis. The success of deploying LMs can be attributed to their ability to follow instructions and learn with human feedback. The key step to achieving the above is LM alignment. Among different options, the Reinforcement Learning from Human Feedback (RLHF) pipeline is a widely recognized approach in aligning LMs from human feedback. Despite the successes, the effectiveness of RLHF relies heavily on the reward model (RM) used in the Proximal Policy Optimization (PPO) stage to guide the learning process. However, there are limitations to the RLHF pipeline and the RLHF pipeline needs further improvement.

### SUMMARY

In a first aspect of the present disclosure, there is provided a method for model training. The method comprises: generating a prompt input using an adversarial machine learning model; providing the prompt input to a target machine learning model, to generate a response to the prompt input; determining a first reward score for the response with respect to the prompt input; and fine-tuning the target machine learning model according to a first optimization objective, the first optimization objective being configured to increase or maximize the first reward score for the target machine learning model.

In a second aspect of the present disclosure, there is provided an apparatus for model training. The apparatus comprises: a prompt generating module configured to generate a prompt input using an adversarial machine learning model; a response generating module configured to providing the prompt input to a target machine learning model, to generate a response to the prompt input; a reward determining module configured to determine a first reward score for the response with respect to the prompt input; and a model fine-tuning module configured to fine-tune the target machine learning model according to a first optimization objective, the first optimization objective being configured to increase or maximize the first reward score for the target machine learning model.

In a third aspect of the present disclosure, there is provided an electronic device. The device comprises at least one processing unit; and at least one memory coupled to the at least one processing unit and storing instructions executable by the at least one processing unit. The instructions, upon execution by the at least one processing unit, cause the device to perform the method of the first aspect.

In a fourth aspect of the present disclosure, a computer-readable storage medium is provided. The medium stores a computer program which, when executed by a processor, causes the method of the first aspect to be implemented.

In a fifth aspect of the present disclosure, a computer program product is provided. The computer program product comprises a computer program which, when executed by a processor, causes the method of the first aspect to be implemented.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates an example diagram for architecture of model training in accordance with some embodiments of the present disclosure;

FIG. 3 illustrates an example algorithm in accordance with some embodiments of the present disclosure;

FIG. 4 illustrates a flow chart of a process for model training in accordance with some embodiments of the present disclosure;

FIG. 5 illustrates a block diagram of an apparatus for model training according to some embodiments of the present disclosure; and

FIG. 6 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically comprising input and output layers and one or more hidden layers between the input and output layers. Neural networks used in deep learning applications typically comprise many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network comprises one or more nodes (also known as processing nodes or neurons), each of which processes input from the previous layer.

Usually, machine learning can roughly comprise three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.”

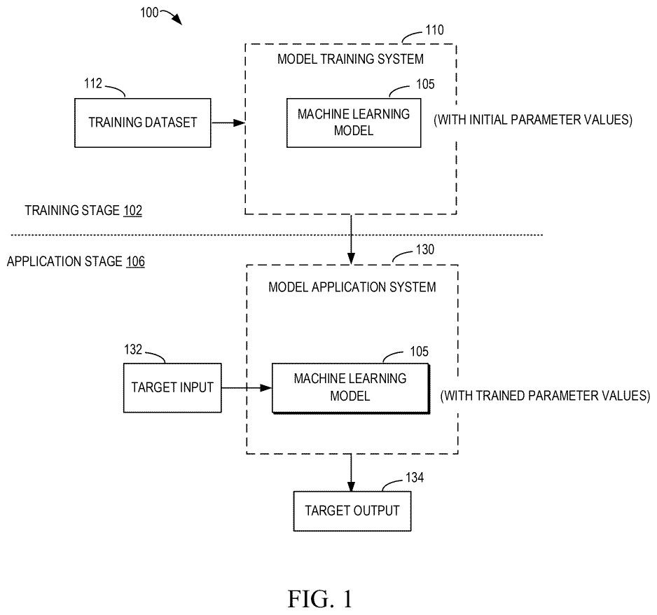

FIG. 1 illustrates a schematic diagram of an example environment 100 in which embodiments of the present disclosure can be implemented. In the environment 100 of FIG. 1, three different stages of a model are shown, including a training stage 102, a fine-tuning stage (not shown), and an application stage 106. After the training or fine-tuning stage is completed, there may also be a validation stage, which is not shown in FIG. 1.

In the training stage 102, a model training system 110 is configured to perform training of a machine learning model 105 using a training dataset 112. At the beginning of training, the model can have initial parameter values. The training process involves updating the parameter values of the machine learning model 105 to expected values based on the training data. In some embodiments, the training stage 102 may involve a pretraining stage and a fine-tuning stage.

In the application stage 106, the obtained machine learning model 105 has trained parameter values that may be provided to a model application system 130 for use. In the application stage 106, the machine learning model 105 can be used to process a target input 132 in actual scenarios and provide a corresponding target output 134. In some embodiments where the machine learning model 105 is capable of question answering, for example, the machine learning model 105 is a generative model for content generation, the target input 132 may be a prompt input (which can be considered as a question), and the target output 134 may be a response or answer for the prompt input. In some examples where the machine learning model 105 is constructed based on a language model, the prompt input may include a text sequence and the response or answer may also include a text sequence for the answer.

In FIG. 1, the model training system 110 and the model application system 130 may include any computing system with computing capability, such as various computing devices/systems, terminal devices, servers, etc. Terminal devices may involve any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the components and arrangements in the environment 100 shown in FIG. 1 are merely examples, and a computing system suitable for implementing the example embodiments described in the present disclosure may include one or more different components, other components, and/or different arrangements. For example, although shown as separate, the model training system 110 and the model application system 130 may be integrated into the same system or device. The implementation of the present disclosure is not restricted in this regard.

It should be understood that the structure and function of each element in the environment 100 is described for illustrative purposes only and does not imply any limitations on the scope of the present disclosure.

Content generative models such as Language models (LMs) have achieved great success due to their remarkable generalization and versatility. Alignment of language models is a critical process designed to ensure that the model's responses to user prompts accurately reflect human intentions and adhere to societal values.

Performing the alignment of LMs requires the preparation of a set of prompts. The traditional alignment method optimizes the model's response on pre-collected prompts, which are mostly contributed by human labelers and could fail to cover all task types. Later, several methods have been proposed to expand the scope of prompts used, including based on difficulty, paraphrase, and self-instruct. Nonetheless, these methods are often rule-based and do not customize or adapt their design to identify prompts that the aligning LM struggles at responding to. Furthermore, using a static prompt dataset may lead to saturation of LM performance due to the loss of discernment by the reward model. Therefore, a more dynamic and adaptive approach is necessary for LM alignment to improve its generalization.

The standard Reinforcement Learning from Human Feedback (RLHF) and Self-finetuning (SFT) framework primarily focuses on optimizing the performance of language models using pre-collected prompts, which are mainly written by humans. Manual creation of these prompts can be tedious and may not cover all possible real-life situations. Further, collecting prompts that provide comprehensive coverage is both tedious and challenging, and often fails to include scenarios that LMs need to improve on the most.

The recent trend has seen a focus on eliciting harmful prompts with a fixed LM. This technique involves generating thousands of prompts using templates like ‘List of questions to ask someone:’, followed by deploying a harmful classifier to detect questions that may yield malicious responses. The identified prompts can also serve as training data for supervised/RL-based LM models. However, these methods only exploit the vulnerabilities of the fixed LM. After training the LM on detected malicious prompts, its weak points may change, making repetitive blind searches time and resource consuming.

To address the above limitations, in example embodiments of the present disclosure, there is provided a solution for adversarial model training. Specifically, generating a prompt input using an adversarial machine learning model; providing the prompt input to a target machine learning model, to generate a response to the prompt input; determining a first reward score for the response with respect to the prompt input; and fine-tuning the target machine learning model according to a first optimization objective, the first optimization objective being configured to increase or maximize the first reward score for the target machine learning model.

With the solution of the present disclosure, a novel framework that conceptualizes the alignment process as a two-agent game, where an adversarial agent (adversarial machine learning model) and a defensive agent (target machine learning model to be fine-tuned) engage in an iterative interaction to either improve its ability to identify the weakness of the defensive agent, or to improve its ability in responding to the prompts that are generated in an adversarial way.

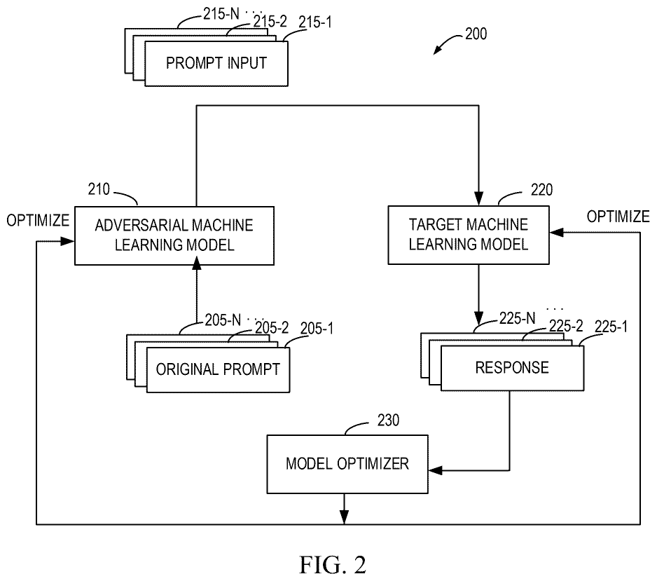

FIG. 2 illustrates an example diagram for architecture 200 of model training in accordance with some embodiments of the present disclosure. In the architecture 200, a target machine learning model 220 is a target model to be trained or fine-tuned. An adversarial machine learning model 210 acts as an adversarial agent to generate prompt inputs to identify weakness of the target machine learning model 220. The target machine learning model 220 is thus considered as a defensive agent. In the following, the target machine learning model and the defensive agent are used interchangeably, and the adversarial machine learning model and the adversarial agent are used interchangeably.

In some embodiments, the target machine learning model 220 and the adversarial machine learning model 210 are constructed based on a single-modal content generative model or a multi-modal content generative model. For example, the target machine learning model 220 and the adversarial machine learning model 210 are constructed to support text input and text output. In other examples, the target machine learning model 220 and the adversarial machine learning model 210 may be constructed to support both text, visual and/or audio modalities of data. In some embodiments, the target machine learning model 220 and the adversarial machine learning model 210 may be constructed based on language models.

The adversarial machine learning model 210 can assess prior errors and current performance, generating prompt inputs to identify potential ineffectiveness of the current target machine learning model 220. Meanwhile, the target machine learning model 220, acting as the student or a defensive agent, continuously improves upon the feedback from the adversarial agent. This iterative process is repeated to continually enhance model performance.

At each step of the optimization, the task of the adversarial machine learning model 210 is to generate prompt inputs that may expose the weakness of the defensive agent, i.e., the target machine learning model 220. In return, the target machine learning model 220 seeks to improve its responses to these newly identified prompt inputs it “struggled” with, based on feedback from the reward model. It has been theoretically demonstrated that this iterative reinforcement learning optimization converges to a Nash Equilibrium for the game induced by the adversarial and defensive agents. Experimental results in safety scenarios demonstrate that learning in such a competitive environment not only fully trains agents but also leads to policies with enhanced generalization capabilities for both adversarial and defensive agents.

More specifically, as illustrated in FIG. 2, the adversarial machine learning model 210 210 generates one or more prompt inputs 215-1, 215-2, . . . , 215-N (collectively or individually referred to as prompt inputs 215). The one or more prompt inputs are then respectively provided the prompt input to a target machine learning model 220, to generate corresponding responses 225-1, 225-2, . . . , 225-N (collectively or individually referred to as responses 225).

An optimizer 230 is configured to determine a reward score for each of the responses 225 with respect to the corresponding prompt input 215, and then fine-tune or optimize the target machine learning model 220 according to a first optimization objective, the first optimization objective being configured to increase or maximize the reward scores for the target machine learning model 220.

In addition, the optimizer 230 may also fine-tune or optimize the adversarial machine learning model 210 according to a second optimization objective which is configured to decrease or minimize the reward scores for the adversarial machine learning model 210.

In some embodiments, the target machine learning model 220 and/or the adversarial machine learning model 210 may be trained or fine-tuned through reinforcement learning (RL), e.g., in the Reinforcement Learning from Human Feedback (RLHF) pipeline.

Before diving into the solution proposed by embodiments of the present disclosure, the present disclosure starts by providing an overview of the basics of LM and the standard RLHF workflow to establish the necessary notations and conceptual framework.

Consider x=(x⁽¹⁾, x⁽²⁾, . . . , x^{(M)})∈ [symbol] as a given prompt input to the LM, where x^{(k)} represents the k-th token in the prompt input. The goal of the LM is to generate a response y=(y⁽¹⁾, y⁽²⁾, . . . , y^{(N)})∈ [symbol] in an auto-regressive manner, governed by the following conditional probability distribution:

$$π ( y \vert x ) = {\prod }_{n = 1}^{N} ℙ ( {y}^{( n )} \vert x , {y}^{( 1 )} , … , {y}^{( n - 1 )} ) . \qquad ( 1 )$$

Here, [symbol] and [symbol] represent the sets of all possible prompt inputs and responses, respectively, and N represents the number of responses, π ( ) represents the LM.

The reinforcement learning from human feedback (RLHF) is a widely adopted framework to align an LM behavior to comply better with human preferences. This process involves three main steps: 1) Supervised Fine-Tuning, 2) Reward Modeling, and 3) RL-based Policy Optimization.

RLHF typically involves collecting human feedback, training a reward model, and optimizing the policy with reinforcement learning (RL). RLHF typically begins with Supervised Fine Tuning (SFT), which fine tunes a pre-trained LM through supervised learning on high-quality samples from downstream tasks. The resulting model is denoted as π_{SFT}.

The second phase of RLHF involves developing a reward model r(⋅,⋅) that reflects human preferences, utilizing annotated data D_{RM}={(x,y_{c},yᵣ)}, where y_{c} and yᵣ represent the chosen and rejected responses to the prompt input x. For instance, in response to a malicious prompt input seeking illegal information, the preferred reaction would be to refuse to answer rather than to comply. One widely-adopted objective is construct a loss function to minimize the negative log-likelihood of the Bradley-Terry (BT) model, so as to assign higher rewards to the chosen response y_{c} over the rejected response yᵣ:

$$ℒ ( r ) = - {𝔼}_{( x , {y}_{c} , {y}_{r} ) ∼ {D}_{RM}} [ log σ ( r ( x , {y}_{c} ) - r ( x , {y}_{r} ) ) ] , \qquad ( 2 )$$

where σ denotes the sigmoid function. r(x,y_{c}) represents a reward score for the pair of the given prompt input x and the chosen response y_{c}, and r(x,yᵣ) represents a reward score for the pair of the given prompt input x and the rejected response yᵣ; and [symbol] represents the expectation.

Finally, RL-based policy optimization, such as PPO, is performed using feedback from the reward model. This optimization targets on a specific set of prompt inputs, denoted as D_{PPO}, with the aim of learning a policy π_{θ} that maximizes rewards regarding D_{PPO} while not drifting too far away from π_{SFT}:

$${max}_{{π}_{θ}} {𝔼}_{x ∼ {D}_{PPO}} [ {𝔼}_{y ∼ {π}_{θ} ( \cdot \vert x )} [ r ( x , y ) ] - β \cdot KL ( {π}_{θ} ( \cdot \vert x ) ‖ {π}_{FST} ( \cdot \vert x ) ) ] , \qquad ( 3 )$$

where KL(⋅∥⋅) is the Kullback-Leibler divergence between two probability distributions.

The real-world effectiveness of π_{θ} strongly depends on the quality and diversity of D_{PPO}. If D_{PPO} fails to comprehensively represent real-world scenarios, π_{θ} may struggle to perform well with prompt inputs encountered in practice. Furthermore, it is crucial that the construction of D_{PPO} dynamically adapts to the capabilities of π_{θ}. Specifically, in each optimization cycle, D_{PPO} should target the current weaknesses of π_{θ}, so that targeted optimization on these vulnerabilities can further improve the overall performance of π_{θ}.

As mentioned above, current alignment methods mainly rely on human-written prompt inputs or rule-based prompt input construction, which obviously cannot ensure the comprehensive coverage and adaptivity mentioned earlier. Embodiments of the present disclosure propose exploring alignment through a two-agent game view to develop the dynamic and comprehensive training environment as previously mentioned.

The embodiments of the present disclosure aim to create a dynamic learning environment for LMs, featuring iterative interactions between an adversarial and a defensive agent, to achieve game-theoretical Preference Optimization (GPO). The adversarial agent (i.e., the adversarial machine learning model 210) acts as the tutor to assess the past errors and current performance of the defensive agent (i.e., the target machine learning model 220) to identify and exploit potential weaknesses. In response, the defensive agent, functioning as the student, continuously adapts and strengthens these identified vulnerabilities. This iterative cycle is repeated to consistently improve performance.

As indicated above, the optimization objective for the target machine learning model 220 is to increase or maximize the reward scores of responses of the target machine learning model 220 to the prompt inputs of the adversarial machine learning model 210, but the optimization objective for the adversarial machine learning model 210 is to decrease or minimize the reward scores.

In some embodiments, a semantic diversity level for a plurality of prompt inputs 215 generated by the adversarial machine learning model 210, and the optimization objective for the adversarial machine learning model 210 is further configured to increase or maximize the diversity level.

As the optimization objectives of the models has a conflict, in some embodiments, the target machine learning model 220 and the adversarial machine learning model 210 are fine-tuned to an equilibrium status.

The target machine learning model 220 is represented by π_{θ} and the adversarial machine learning model 210 is represented by μ_{φ}, each of which may be implemented by separate LMs. The game between the target machine learning model 220 and the adversarial machine learning model 210 is then formulated as the following max-min optimization problem:

$${max}_{{π}_{θ}} {min}_{{μ}_{ϕ}} J ( {π}_{θ} , {μ}_{ϕ} ) := {𝔼}_{x ∼ {μ}_{ϕ} ( \cdot )} [ {𝔼}_{y ∼ {π}_{θ} ( \cdot \vert x )} [ r ( x , y ) ] - {R}_{div} ( x ) ] , \qquad ( 4 )$$

Here, r(x,y) is the reward score that is determined using a trained reward model as described above, which captures the quality of response y to the prompt input x. The diversity reward (or diversity level) R_{div}(x) relates to the prompt input x and measures whether the generated prompt inputs are similar to or common among previous generations. A higher R_{div}(x) implies that the prompt input x is less common.

Theoretically, it has been demonstrated that this iterative adversarial alignment process converges to a Nash equilibrium between the adversarial and defensive agents. This equilibrium signifies a state where neither agent can unilaterally improve their strategy, implying a more comprehensive training process that leads to better coverage of prompts for alignment. The experiments, conducted by the inventors in scenarios involving harmful inputs and jailbreak settings, validate the effectiveness of the proposed method. The results show that the approach disclosed herein not only enhances the generalization capabilities of the agents but also ensures that both parties in the interaction are thoroughly trained. Further, the adversarial agent served as an adaptive red teaming partner that continuously generated challenging prompts for aligning the defensive LM.

Next, it will elaborate on the objectives of each agent in the optimization objective as described in Eq. (4).

The adversarial machine learning model 210 μ_{φ} acts as a prompt input generator, aiming to generate diverse prompt inputs 215 that expose the weaknesses of the current defensive agent π_{θ}. More specifically, it generates a prompt input x to minimize the reward score r(x,y), where y is generated by the target machine learning model 220 π_{θ}, while maximizing the diversity reward R_{div}(x) to encourage prompt inputs that are less common or similar to previous generations.

In some embodiments, a dynamically generated prompt input or a template prompt input may be provided to the adversarial machine learning model 210, to generate the prompt input for the target machine learning model 220.

The defensive agent, i.e., the target machine learning model 220 π_{θ} functions as the previous LM policy in RLHF, aiming to maximize the reward scores of the generated responses, i.e., [symbol] _{y~π}_{_{θ}}_{(⋅|x)}[r(x,y)], when the prompt input x is sampled from the prompt input distribution U specified by the adversarial agent.

Overall, the objective in Eq. (4) describes a zero-sum two-player game between the two agents, with R(x,y)=r(x,y)−R_{div}(x) as the overall reward. The adversarial agent operates on the prompt input x to minimize the overall reward R(x,y), while the defensive agent improves the response y to maximize the overall reward R(x,y).

In practical implementations, both the target machine learning model 220 and the adversarial machine learning model 210 may be iteratively optimized using PPO as the optimization method, where a KL-regularizer between the current policy and the old policy is introduced to stable the training process in each iteration.

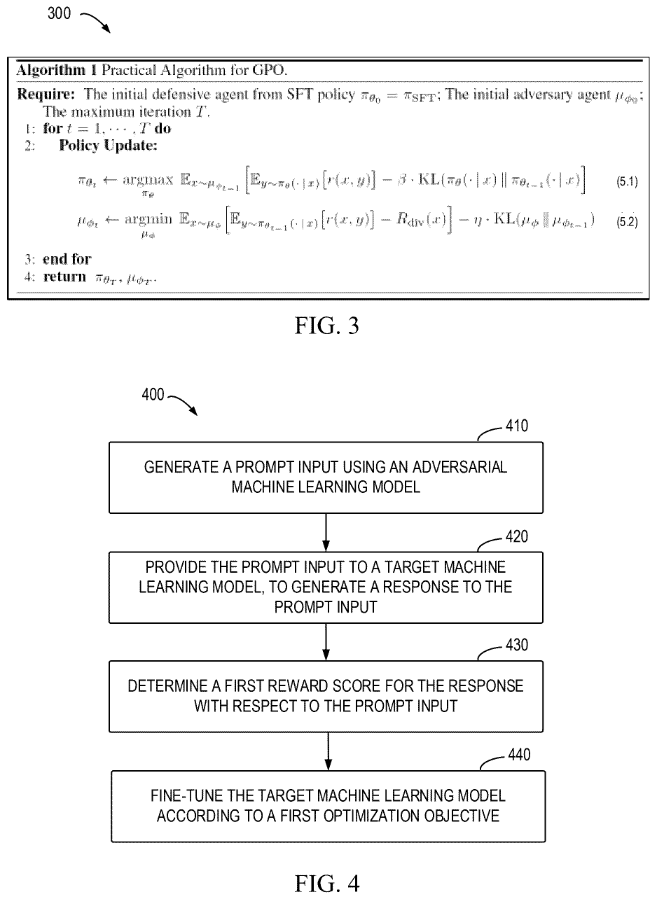

The whole framework is described in Algorithm 1 as shown in FIG. 3. The optimization objective for the target machine learning model 220 is as follows:

$${π}_{{θ}_{t}} ← {arg max}_{{π}_{θ}} {𝔼}_{x ∼ / {t}_{{ϕ}_{t - 1}}} [ {𝔼}_{y ∼ {π}_{θ} ( \cdot \vert x )} [ r ( x , y ) ] - β \cdot KL ( {π}_{θ} ( \cdot \vert x ) ‖ {π}_{{θ}_{t - 1}} ( \cdot \vert x ) ] \qquad ( 5.1 )$$

where r(x,y) represents the reward score of the response y to the prompt input x (which is expected to be a higher score for the target machine learning model 220); KL( ) represents a divergence level between the response and a previous response generated by the target machine learning model 220 (which is expected to be a lower level). In this context, the KL divergence term serves two main purposes. First, it acts as an entropy bonus, maintaining generation diversity and preventing the collapse of patterns into a single high-reward answer. Second, it ensures that the outputs of the RL policy do not deviate significantly from the distribution of the reference model.

The optimization objective for the adversarial machine learning model 210 is as follows:

$${μ}_{{ϕ}_{t}} ← {arg min}_{{μ}_{ϕ}} {𝔼}_{x ∼ {μ}_{ϕ}} ⌊ {𝔼}_{y ∼ {π}_{{θ}_{t - 1}} ( \cdot \vert x )} [ r ( x , y ) ] - {R}_{div} ( x ) ⌋ - η \cdot KL ( {μ}_{ϕ} ‖ {{μ}_{ϕ}}_{t - 1} ) \qquad ( 5.2 )$$

where r(x,y) represents the reward score of the response y to the prompt input x (which is expected to be a lower score for the target machine learning model 220); R_{div}(x) represents the diversity reward (which is expected to be a higher level); and KL( ) represents a divergence level between the prompt input and a previous prompt input generated by the adversarial machine learning model 210 (which is expected to be a lower level).

The optimization objective in Eq. (5.1) describes the optimization objective for the defensive agent π_{θ} in each iteration round t. One can observe that the updating formula is quite similar to the objective of RL optimization in the standard RLHF framework described in Eq. (3). The main differences are: (1) prompt inputs, which are sampled from the distribution generated by the adversarial agent in the last round μ_{φ}_{_{t−1}}, rather than from the pre-fixed prompt input dataset D_{PPO}; (2) in each round t, the KL penalization is applied between π_{θ}_{ₜ}, and π_{θ}_{_{t−1}}, as the defensive agent starts from its state in the last round.

When optimizing the adversarial agent μ_{φ} according to the optimization objective in Eq. (5.2), as discussed earlier, the objective is not only to elicit low rewards from the defensive agent but also to prioritize diversity in prompt input generation by maximizing the diversity reward R(x) of the generated prompt input x. Encouraging diversity of generations promotes exploration and prevents the adversarial agent from focusing on a narrow set of prompt inputs, ultimately enhancing the robustness and generalizability of both agents. Furthermore, the diversity term R_{div}(x) prevents the adversarial agent from converging to a point distribution at the Nash Equilibrium for the game defined in Eq. (4). Similar to optimizing the defensive LM, a KL regularization term is added between μ_{φ}_{ₜ}, and μ_{φ}_{_{t−1}}, for stable learning.

In some embodiments, the optimization of two-agent alignment may focus on safety scenarios, concretizing the two-agent framework, as a major challenge in deploying LMs is ensuring robustness to various malicious prompts that may elicit misinformation and harmful content. In the safety scenario, the adversarial machine learning model 210 may conduct red-teaming to identify prompt inputs, while the target machine learning model 220 may aim to be robust against various prompt inputs generated by the adversarial agent. We then elaborate on the design of the response-quality related reward score r(⋅,⋅) and the diversity reward R_{div}(⋅) in the safety scenario.

In safety alignment, r(x,y), the quality of response y to the prompt x, is defined as the safety level of the model's output y given a user input prompt x. This is typically determined by the probability of being classified as safe by a toxicity classifier. When determining the first reward score comprises, a response 225 from the target machine learning model 220 may be classified by a toxicity classifier, to obtain a probability of the response being classified as a toxicity response given the prompt input 215. Then the reward score for the response 225 may be determined based on the probability, where the reword score is determined as a higher score if the probability is determined as a lower value.

As discussed, the adversarial machine learning model 210 aims to discover the weaknesses of defensive agents as much as possible, generating more diverse prompts that can harm the safety of defensive agents.

Therefore, in some embodiments, text similarity of prompt inputs may be utilized to previous generations as its diversity reward, assuming that the prompt inputs 215 and responses 225 are in text form, e.g., including one or more sentences. The lower the similarity between the current adversarial prompt inputs and previous generations, the greater the diversity level. In some embodiments, n-gram modeling and sentence embeddings may be utilized to measure the similarity of text in form and semantics, respectively.

For n-gram modeling (R_{SelfBLEU}), the SelfBLEU score derived from the BLEU score may measure the n-gram overlap between a generated sentence x and a set of reference sentences X. Within the SelfBLEU framework, the newly generated sentence is compared against all previously generated sentences as the reference set. If the new sentence x shares numerous n-gram segments with previous sentences, indicating a high degree of similarity, it will receive a higher SelfBLEU score, suggesting that its content is highly repetitive compared to the previously generated sentences. The negative average SelfBLEU score may be used as a diversity reward rSelfBLEU to ensure that the adversarial machine learning model 210 generates diverse prompt samples:

$${R}_{SelfBLEU} ( x ) = - \frac{1}{5} {\sum }_{n = 1}^{5} {SelfBLEU}_{X} ( x , n ) . \qquad ( 6 )$$

For sentence embedding (R_{Embedding}), in order to encourage semantic diversity of generated prompts, it needs to measure not only the similarity in the form of text, but also the semantics. To achieve this, a sentence embedding model φ is used, which can capture semantic differences between text. Sentence embedding models produce low-dimensional vectors as sentence embeddings, and cosine similarity between two embeddings correlates to semantic similarity between sentences. To measure semantic novelty, a diversity reward called R_{Embedding} is introduced, which involves taking the cosine similarity between the sentence embeddings of the current generated prompt input and all previously generated prompt inputs:

$${R}_{Embedding} ( x ) = - {\sum }_{{x}^{′} ∈ X} \frac{ϕ ( x ) \cdot ϕ ( {x}^{′} )}{{‖ ϕ ( x ) {‖}^{2} ‖ ϕ ( {x}^{′} ) ‖}^{2}} , \qquad ( 7 )$$

where X represents the set of all previously generated prompt inputs. In some embodiments, the diversity level, R_{div}, may be defined as (R_{selfBLEU}+R_{Embedding})/2. In other embodiments, R_{div} may be directly defined as R_{selfBLEU} Or R_{Embedding}.

With the quality-related reward r and diversity reward R_{div} defined above, the target machine learning model 220 and the adversarial machine learning model 210 can be optimized iteratively following Eq. (5.1) and Eq. (5.2) as in the example algorithm 300 of FIG. 3. This leads to strengthened prompt inputs (generated by the adversarial agent) and a more robust defensive target machine learning model, as demonstrated in the empirical evaluation later on.

As indicated above, through the iterative optimization between the adversarial and defensive agents, the system reaches a Nash Equilibrium, i.e., no agent can achieve a higher reward by changing its policy unilaterally. In other words, at the Nash Equilibrium, the defensive agent achieves the highest reward under the prompt distribution given by the adversarial agent, while the adversarial agent has already generated the most challenging prompts.

For better understanding the two-agent optimization disclosed herein, there is provided a theoretical guarantee for the algorithm proposed herein in the perspective of games and show that the adversarial agent and the defensive agent converge to the Nash Equilibrium asymptotically.

For the purpose of theoretical analysis, the practical algorithm may be changed a bit to make it return the average policies

$${\hat{π}}_{T} ( \cdot \vert x ) = \frac{1}{T} {\sum }_{t = 1}^{T} {π}_{{θ}_{t}} ( \cdot \vert x )$$

for any x∈X and

$${\hat{μ}}_{T} ( \cdot ) = \frac{1}{T} {\sum }_{t = 1}^{T} {μ}_{{θ}_{t}} ( \cdot )$$

instead of the last iteration policies π_{θ}_{ₜ} and μ_{φ}_{ₜ}. Let the initial policies π_{θ}_{₀} and μ_{φ}_{₀} be uniform distributions. It can also ignore the optimization error and assume the maxima and minima are attained by the two agents in Eq. (5.1) and Eq. (5.2), respectively. The resulting algorithm is considered as the theoretical version of Algorithm 1 and present it as Algorithm 2 in the appendix. For the subsequent section, for ease of illustration, π_{θ} and μ_{φ} are abbreviated as π and μ, respectively.

Since the objective J(π,μ) is linear in both π and μ, it can be known that the Nash equilibrium exists. Also, following from the minimax theorem, it can have

$${min}_{μ} {max}_{π} J ( π , μ ) = {max}_{π} {min}_{μ} J ( π , μ ) = {J}^{*} , \qquad ( 8 )$$

where J* is called the value of the game. When J(π,μ)/=J*, the following Nash gap is defined to measure how close the policy pair (π,μ) is to the Nash equilibrium,

$$NEGap ( π , μ ) := {max}_{{π}^{†}} J ( {π}^{†} , μ ) - {min}_{{μ}^{†}} J ( π , {μ}^{†} ) \qquad ( 9 )$$

Definition 3.1 (e-approximate Nash Equilibrium). For any ε>0, a pair of policies (π,μ) is an ε-approximate Nash Equilibrium (ϵ−NE) if NEGap(π,μ)≤ϵ. Note that if NEGap(π,μ)=0, then the pair of policies (π,μ) is Nash Equilibrium.

Theorem 3.2. By choosing proper parameters β,η= [symbol] \sqrt{T}), the average policies \hat{π}_{T}, \hat{μ}_{T} given by the theoretical version of Algorithm 1 satisfies

$$NEGap ( {\hat{π}}_{T} , {\hat{μ}}_{T} ) \leq 𝒪 ( {T}^{- 1 / 2} ) . \qquad ( 10 )$$

Theorem 3.2 demonstrates that Algorithm 1 can find an O(T^{-1/2})-approximate Nash equilibrium in T iterations. Intuitively, agents in Algorithm 1 arrive at a Coarse-Correlated Equilibrium (CCE) for infinity iterations since they both adopt Follow-the-Regularized Leader algorithm (FTRL) which is a no-regret algorithm. Because a CCE in zero-sum games is guaranteed to be a Nash Equilibrium, it can finally show the algorithm leads to a Nash equilibrium for infinity iterations.

The above analysis treats the diversity score as part of the reward function. To emphasize the importance of the diversity score, a case study is performed by analyzing a variant of Algorithm 1 where R_{div}(x)=Rₑₙₜ(x)=γ·log μₜ₋₁(x) in Eq. (5.2), which corresponds to adopting cross entropy between μₜ and μₜ₋₁ as a proxy of the diversity score. The cross-entropy bonus encourages the adversarial agent to generate prompts different from the last iteration and has similar function as the diversity rewards. It presents the resulting algorithm as Algorithm 3 and it can be shown that Algorithm 3 optimizes the following objective

$${max}_{π} {min}_{μ} {𝔼}_{x ∼ μ} [ {𝔼}_{y ∼ π ( \cdot \vert x )} [ r ( x , y ) ] ] - γ \cdot ℋ ( μ ) \qquad ( 11 )$$

where [symbol] (μ)=− [symbol] μ(x)log μ(x) Under mild assumptions, it shows that Algorithm 3 has the same theoretical guarantee as Theorem 3.2. The analysis can be found in Section A.2. Notice that even though the theoretical guarantees are the same, the adversarial agent converges to a one-point distribution at argmin_{x∈X} [symbol] _{y~π(⋅|x)}[r(x,y)] without the entropy regularizer in (3.7), which is undesirable in practice.

In the embodiments of the present disclosure, =a dynamic learning environment is established where an adversarial agent evaluates the past mistakes and current performance of a defensive agent to pinpoint and exploit potential vulnerabilities. In response, the defensive agent continuously adapts and reinforces these identified weaknesses, thereby improving performance through this iterative process.

FIG. 4 illustrates a flowchart of a process 400 for model training in accordance with some embodiments of the present disclosure. The process 400 may be implemented at the model training system 110 of FIG. 1.

At block 410, the model training system 110 generates a prompt input using an adversarial machine learning model.

At block 420, the model training system 110 provides the prompt input to a target machine learning model, to generate a response to the prompt input.

At block 430, the model training system 110 determines a first reward score for the response with respect to the prompt input.

At block 440, the model training system 110 fine-tunes the target machine learning model according to a first optimization objective, the first optimization objective being configured to increase or maximize the first reward score for the target machine learning model.

In some embodiments, the process 400 further comprises: fine-tuning the adversarial machine learning model according to a second optimization objective, the second optimization objective being configured to decrease or minimize the first reward score for the adversarial machine learning model.

In some embodiments, the process 400 further comprises: determining a semantic diversity level for a plurality of prompt inputs generated by the adversarial machine learning model, the plurality of prompt inputs comprising the prompt input. In some embodiments, the second optimization objective is further configured to increase or maximize the diversity level for the adversarial machine learning model.

In some embodiments, the target machine learning model and the adversarial machine learning model are fine-tuned to an equilibrium status.

In some embodiments, the first optimization objective is configured to decrease or minimize a divergence level between the response and a previous response generated by the target machine learning model. In some embodiments, the second optimization objective is configured to decrease or minimize a divergence level between the prompt input and a previous prompt input generated by the adversarial machine learning model.

In some embodiments, generating the plurality of prompt inputs comprises: providing a generated prompt input or a template prompt input to the adversarial machine learning model, to generate the prompt input.

In some embodiments, determining the first reward score comprises: determining a probability of the response being classified as a toxicity response given the prompt input; and determining the first reward score based on the probability. In some embodiments, the first reword score is determined as a higher score if the probability is determined as a lower value.

In some embodiments, fine-tuning the target machine learning model comprises: fine-tuning the target machine learning model through reinforcement learning based on the first optimization objective.

In some embodiments, the target machine learning model and the adversarial machine learning model are constructed based on a single-modal or multi-modal content generative model.

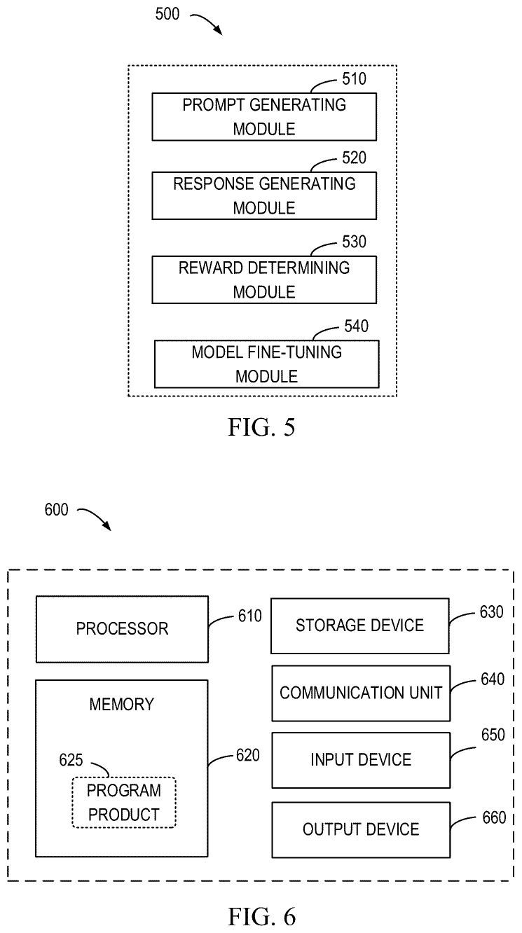

FIG. 5 shows a block diagram of an apparatus 500 for model training in accordance with some embodiments of the present disclosure. The apparatus 500 may be implemented, for example, or included at the model training system 110 of FIG. 1. Various modules/components in the apparatus 500 may be implemented by hardware, software, firmware, or any combination thereof.

As shown, the apparatus 500 includes a prompt generating module 510 configured to generate a prompt input using an adversarial machine learning model; a response generating module 520 configured to providing the prompt input to a target machine learning model, to generate a response to the prompt input; a reward determining module 530 configured to determine a first reward score for the response with respect to the prompt input; and a model fine-tuning module 540 configured to fine-tune the target machine learning model according to a first optimization objective, the first optimization objective being configured to increase or maximize the first reward score for the target machine learning model.

In some embodiments, the model fine-tuning module 540 is further configured to: fine-tuning the adversarial machine learning model according to a second optimization objective, the second optimization objective being configured to decrease or minimize the first reward score for the adversarial machine learning model.

In some embodiments, the apparatus 500 further comprises a diversity determining module configured to: determine a semantic diversity level for a plurality of prompt inputs generated by the adversarial machine learning model, the plurality of prompt inputs comprising the prompt input. In some embodiments, the second optimization objective is further configured to increase or maximize the diversity level for the adversarial machine learning model.

In some embodiments, the target machine learning model and the adversarial machine learning model are fine-tuned to an equilibrium status.

In some embodiments, the first optimization objective is configured to decrease or minimize a divergence level between the response and a previous response generated by the target machine learning model. In some embodiments, the second optimization objective is configured to decrease or minimize a divergence level between the prompt input and a previous prompt input generated by the adversarial machine learning model.

In some embodiments, the prompt generating module 510 is configured to: provide a generated prompt input or a template prompt input to the adversarial machine learning model, to generate the prompt input.

In some embodiments, the reward determining module 530 is configured to: determine a probability of the response being classified as a toxicity response given the prompt input; and determine the first reward score based on the probability. In some embodiments, the first reword score is determined as a higher score if the probability is determined as a lower value.

In some embodiments, the model fine-tuning module 540 is configured to: fine-tune the target machine learning model through reinforcement learning based on the first optimization objective.

In some embodiments, the target machine learning model and the adversarial machine learning model are constructed based on a single-modal or multi-modal content generative model.

FIG. 6 illustrates a block diagram of an electronic device 600 in which one or more embodiments of the present disclosure can be implemented. It would be appreciated that the electronic device 600 shown in FIG. 6 is only an example and should not constitute any restriction on the function and scope of the embodiments described herein. The electronic device 600 may be used, for example, to implement the model training system 110 of FIG. 1. The electronic device 600 may also be used to implement the apparatus 400 of FIG. 4.

As shown in FIG. 6, the electronic device 600 is in the form of a general computing device. The components of the electronic device 600 may include, but are not limited to, one or more processors or processing units 610, a memory 620, a storage device 630, one or more communication units 640, one or more input devices 660, and one or more output devices 660. The processing unit 610 may be an actual or virtual processor and can execute various processes according to the programs stored in the memory 620. In a multiprocessor system, multiple processing units execute computer executable instructions in parallel to improve the parallel processing capability of the electronic device 600.

The electronic device 600 typically includes a variety of computer storage medium. Such medium may be any available medium that is accessible to the electronic device 600, including but not limited to volatile and non-volatile medium, removable and non-removable medium. The memory 620 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 630 may be any removable or non-removable medium, and may include a machine-readable medium, such as a flash drive, a disk, or any other medium, which can be used to store information and/or data (such as training data for training) and can be accessed within the electronic device 600.

The electronic device 600 may further include additional removable/non-removable, volatile/non-volatile storage medium. Although not shown in FIG. 6, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 620 may include a computer program product 625, which has one or more program modules configured to perform various methods or acts of various embodiments of the present disclosure.

The communication unit 640 communicates with a further computing device through the communication medium. In addition, functions of components in the electronic device 600 may be implemented by a single computing cluster or multiple computing machines, which can communicate through a communication connection. Therefore, the electronic device 600 may be operated in a networking environment using a logical connection with one or more other servers, a network personal computer (PC), or another network node.

The input device 660 may be one or more input devices, such as a mouse, a keyboard, a trackball, etc. The output device 660 may be one or more output devices, such as a display, a speaker, a printer, etc. The electronic device 600 may also communicate with one or more external devices (not shown) through the communication unit 640 as required. The external device, such as a storage device, a display device, etc., communicate with one or more devices that enable users to interact with the electronic device 600, or communicate with any device (for example, a network card, a modem, etc.) that makes the electronic device 600 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method for model training, comprising:
generating a prompt input using an adversarial machine learning model;
providing the prompt input to a target machine learning model, to generate a response to the prompt input;
determining a first reward score for the response with respect to the prompt input; and
fine-tuning the target machine learning model according to a first optimization objective, the first optimization objective being configured to increase or maximize the first reward score for the target machine learning model.

2. The method of claim 1, further comprising:
fine-tuning the adversarial machine learning model according to a second optimization objective, the second optimization objective being configured to decrease or minimize the first reward score for the adversarial machine learning model.

3. The method of claim 2, further comprising:
determining a semantic diversity level for a plurality of prompt inputs generated by the adversarial machine learning model, the plurality of prompt inputs comprising the prompt input; and
wherein the second optimization objective is further configured to increase or maximize the diversity level for the adversarial machine learning model.

4. The method of claim 2, wherein the target machine learning model and the adversarial machine learning model are fine-tuned to an equilibrium status.

5. The method of claim 1, wherein the first optimization objective is configured to decrease or minimize a divergence level between the response and a previous response generated by the target machine learning model; and/or
wherein the second optimization objective is configured to decrease or minimize a divergence level between the prompt input and a previous prompt input generated by the adversarial machine learning model.

6. The method of claim 1, wherein generating the plurality of prompt inputs comprises:
providing a generated prompt input or a template prompt input to the adversarial machine learning model, to generate the prompt input.

7. The method of claim 1, wherein determining the first reward score comprises:
determining a probability of the response being classified as a toxicity response given the prompt input; and
determining the first reward score based on the probability,
wherein the first reward score is determined as a higher score if the probability is determined as a lower value.

8. The method of claim 1, wherein fine-tuning the target machine learning model comprises:
fine-tuning the target machine learning model through reinforcement learning based on the first optimization objective.

9. The method of claim 1, wherein the target machine learning model and the adversarial machine learning model are constructed based on a single-modal or multi-modal content generative model.

10. (canceled)

11. An electronic device, comprising:
at least one processor; and
at least one memory coupled to the at least one processor and storing instructions executable by the at least one processor, the instructions, upon execution by the at least one processor, causing the device to perform acts comprising:
generating a prompt input using an adversarial machine learning model;
providing the prompt input to a target machine learning model, to generate a response to the prompt input;
determining a first reward score for the response with respect to the prompt input; and
fine-tuning the target machine learning model according to a first optimization objective, the first optimization objective being configured to increase or maximize the first reward score for the target machine learning model.

12. The electronic device of claim 11, wherein the acts further comprise:
fine-tuning the adversarial machine learning model according to a second optimization objective, the second optimization objective being configured to decrease or minimize the first reward score for the adversarial machine learning model.

13. The electronic device of claim 12, wherein the acts further comprise: determining a semantic diversity level for a plurality of prompt inputs generated by the adversarial machine learning model, the plurality of prompt inputs comprising the prompt input; and
wherein the second optimization objective is further configured to increase or maximize the diversity level for the adversarial machine learning model.

14. The electronic device of claim 12, wherein the target machine learning model and the adversarial machine learning model are fine-tuned to an equilibrium status.

15. The electronic device of claim 11, wherein the first optimization objective is configured to decrease or minimize a divergence level between the response and a previous response generated by the target machine learning model; and/or
wherein the second optimization objective is configured to decrease or minimize a divergence level between the prompt input and a previous prompt input generated by the adversarial machine learning model.

16. The electronic device of claim 11, wherein generating the plurality of prompt inputs comprises:
providing a generated prompt input or a template prompt input to the adversarial machine learning model, to generate the prompt input.

17. The electronic device of claim 11, wherein determining the first reward score comprises:
determining a probability of the response being classified as a toxicity response given the prompt input; and
determining the first reward score based on the probability,
wherein the first reward score is determined as a higher score if the probability is determined as a lower value.

18. The electronic device of claim 11, wherein fine-tuning the target machine learning model comprises:
fine-tuning the target machine learning model through reinforcement learning based on the first optimization objective.

19. A non-transitory computer-readable storage medium, having a computer executable instructions stored thereon which, upon execution by an electronic device, causes the device to perform acts comprising:
generating a prompt input using an adversarial machine learning model;
providing the prompt input to a target machine learning model, to generate a response to the prompt input;
determining a first reward score for the response with respect to the prompt input; and
fine-tuning the target machine learning model according to a first optimization objective, the first optimization objective being configured to increase or maximize the first reward score for the target machine learning model.

20. (canceled)

21. The non-transitory computer-readable storage medium of claim 19, wherein the acts further comprise:
fine-tuning the adversarial machine learning model according to a second optimization objective, the second optimization objective being configured to decrease or minimize the first reward score for the adversarial machine learning model.

22. The non-transitory computer-readable storage medium of claim 21, wherein the acts further comprise:
determining a semantic diversity level for a plurality of prompt inputs generated by the adversarial machine learning model, the plurality of prompt inputs comprising the prompt input; and
wherein the second optimization objective is further configured to increase or maximize the diversity level for the adversarial machine learning model.
